(19) United States
(12) Patent Application Publication
(10) Pub. No.: US 2013/0319958 A1
(43) Pub. Date: Dec. 5, 2013

(54) MULTI-FUNCTIONAL DISPOSABLE SEPARATORY FUNNELS

(71) Applicants: Jianjian Cai, Dover, MA (US); Xiaogao Liu, Dover, MA (US)

(72) Inventors: Jianjian Cai, Dover, MA (US); Xiaogao Liu, Dover, MA (US)

(73) Assignee: CHEMRUS INC., Dover, MA (US)

(21) Appl. No.: 13/989,928

(22) PCT Filed: Nov. 28, 2011
(86) PCT No.: PCT/US11/62216

§ 371 Date: Aug. 13, 2013

Related U.S. Application Data
(60) Provisional application No. 61/418,192, filed on Nov. 30, 2010.

(51) Int. Cl. B01D 29/085

(52) U.S. Cl. CPC B01D 29/085
USPC 210/808; 210/497.3; 264/328.14

(57) ABSTRACT

This invention incorporates barrel-shaped polymer-structured separatory funnels. The separatory funnels are made from an injection molding machine using cheaper plastic resins such as polypropylene, or polyethylene instead of glass in order to lower costs, so they are ready-to-use and disposable. The innovative separatory funnels have multi-functional features, which can be used as regular separatory funnels for liquid-liquid phase separation and extraction, as receiving receptacles to take the filtrate in a solid-liquid filtration apparatus, and also as flasks hooked in a rotary evaporator to evaporate solvents.

### CLAIM OF PRIORITY

This application claims priority to U.S. Patent Application No. 61/418,192, filed Nov. 30, 2010, which is incorporated by reference in its entirety.

### BACKGROUND OF THE INVENTION

1. Field of the Invention

This invention relates to a separatory funnel and more specifically the polymer-structured separatory funnels are made from an injection molding machine using plastic resins as materials.

2. Description of Prior Art

Liquid-liquid phase extraction/separation is a common technique used to separate the components of a mixture between two immiscible solvent phases. The most popular separatory funnels are made of glass, which have the shape of a cone surmounted by a hemisphere. They have a ground joint at the top end for transferring liquid phases and a stopcock at the bottom with a stem for controlling the drained liquid phases. Considering the corrosion of glass with hydrogen fluoride, TEFLON plastic separatory funnels can be used for phase extraction/separation containing hydrogen fluoride.

Commercially available glass separatory funnels are expensive and non-disposable because the funnels with a ground joint at the top and a TEFLON stopcock at the bottom are made by hand. They all have one feature: to perform liquid-liquid phase separations/extractions. Usually, to work-up a chemical reaction involves multiple processes such as liquid-liquid phase extraction/separation with a separatory funnel, solid-liquid filtration with a filtration apparatus, and solvent evaporation with a rotary evaporator. Various pieces of laboratory glassware such as separatory funnels, Erlenmeyer flasks, and round bottle flasks are used for work-up purposes. However, all glassware needs to be cleaned afterwards in order to be used again. The cleaning process is time consuming, and breakage can occur during the cleaning process very often. In fact, it can be inconvenient to clean contaminated glassware.

The commercially available blow-molded separatory funnels are low precision polymer products that can be prone to leakage. In order to address this problem, the stopcock in a blow-molded separatory funnel requires a higher precision otherwise leaking may occur. Therefore, the commercially available polymer-structured separatory funnels consist of two parts: a low precision separatory funnel body and a highly precise TEFLON stopcock. However, the TEFLON stopcock can be expensive.

### SUMMARY OF THE INVENTION

This invention relates to a polymer-structured separatory funnels made from an injection molding machine using plastic resins. An injection-molded separatory funnel has adequate structural precision to make the funnel usable while also being disposable due to their lower production cost and less expensive materials compared to blow molded and/or TEFLON-containing counterparts.

These specially-designed funnels have multi-functional features, which are designed to facilitate their usage in a variety of situations. For example, the polymer-structured separatory funnel can be used as regular separatory funnels in liquid-liquid phase separation/extraction, as receiving receptacles in solid-liquid filtration apparatus, and also as flasks hooked onto a regular rotary evaporator for solvent evaporation.

In the invention, the polymer-structured separatory funnels are made from an injection molding machine rather than blow molding machine because the injection mold can produce high precision polymer products with good transparency. With the injection mold, the polymer-structured separatory funnels can be made in one piece. However large size funnels may be difficult to be made in one piece. The funnel made in two-piece is an option, which consists of a funnel body with a male luer-lock joint at the bottom end, and a stopcock with a female joint. Considering the manufacture with injection mold, the funnels are designed to have a barrel-shaped body with a screw threaded joint at the top end for transferring liquid phases and a one-way on/off stopcock at the bottom with a stem for controlling the drained liquid phases. The polymer-structured separatory funnels made from an injection molding machine use cheaper plastic resins such as, for example, polypropylene or polyethylene, so they are highly precise, good transparency, cheaper and disposable. Furthermore, the polymer-structured separatory funnels have multi-functional features. They can be used as separatory funnels for liquid-liquid extraction, as filtrate receiving receptacles in solid-liquid filtration, and as flasks hooked to a rotary evaporator for solvent evaporation.

In one aspect, a multi-functional separatory funnel includes a separatory funnel body having a top end and a bottom, a one-way on/off stopcock at the bottom, and a screw threaded joint at the top end. The separatory funnel can include a screw threaded cap configured to mate with the screw threaded joint. The separatory funnel body can include an injection molded polymeric material. The separatory funnel can be disposable. The separatory funnel body can be a barrel-shaped upper portion adjacent to the top end and a cone-shaped lower portion adjacent to the bottom. The body can include an indent on the top end part configured to be held with a support ring. The polymeric material of the separatory funnel can include polypropylene or polyethylene. The separatory funnel can include a vacuum take-off adapter configured to mate with the screw threaded joint. The adapter can include a screw threaded joint and a ground joint opposite the threaded joint. Alternatively, the adapter can include a first screw threaded joint and a second screw threaded joint opposite the first screw threaded joint. The polymeric material of the adapter can be selected from the group including polypropylene, polyethylene, fluorinated polyethylene, or polyvinylidene fluoride. The ground joint of the adapter can have a size of 14/20, 19/22, 24/40 or 29/42.

In another aspect, a method of manufacturing a separatory funnel includes feeding a polymer resin into a hopper, melting the polymer resin, injecting the polymer resin into a mold including a separatory funnel body having a top end and a bottom, a one-way on/off stopcock at the bottom, and a screw threaded joint at the top end, and cooling the polymer resin to form the funnel.

In another aspect, a method of using a separatory funnel comprising applying reduced pressure to an internal volume of the separatory funnel. Applying reduced pressure includes attaching the separatory funnel to a rotary evaporator to evaporate volatile material. A polymer-structured adapter can couple the separatory funnel with the rotary evaporator. The method can include performing a liquid-liquid phase separation and extraction prior to applying reduced pressure or receiving a filtrate directly from a solid-liquid filtration apparatus into the separatory funnel prior to applying reduced pressure.

### BRIEF DESCRIPTION OF THE DRAWING

FIG. 1 is a partially exploded view of the barrel-shaped polymer-structured separatory funnel according to the present invention.

FIG. 2 is a side view of the assembled barrel-shaped polymer-structured separatory funnel according to the present invention.

FIG. 3 is a partially exploded view of the large size separatory funnel with a support ring according to the present invention.

FIG. 4 is a partially exploded view of the separatory funnel consisting of a barrel-shaped polymer-structured separatory funnel body, a polymer-structured cap, and a polymer-structured stopcock according to the present invention.

FIG. 5 is a partially exploded view of the solid-liquid filtration apparatus, which consists of a polymer-structured filter funnel, a glass vacuum take-off adapter, a polymer-structured adapter, and a polymer-structured separatory funnel according to the present invention.

FIG. 6 is a partially exploded view of the solid-liquid filtration kit of our previous patent, which includes a polymer-structured filter funnel, a glass vacuum take-off adapter, a polymer-structured adapter, and a glass vial according to the present invention.

FIG. 7 is a partially exploded view of a partial rotary evaporator apparatus, which consists of a polymer-structured separatory funnel, a polymer-structured adapter, a water bath container, and a glass ground joint of rotary evaporator according to the present invention.

### DETAILED DESCRIPTION

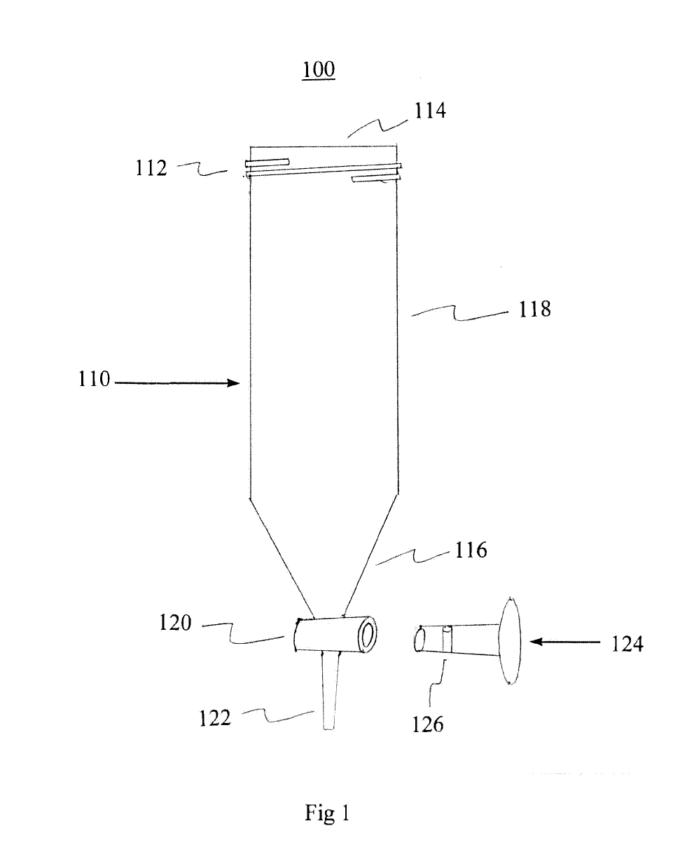

The present invention relates to disposable polymer-structured separatory funnels. With reference to FIG. 1, an environmental, partially exploded side view of the disposable polymer-structured separatory funnel, generally indicated by numeral 100, is shown. The separatory funnel 100 consists of a separatory funnel body 110 and an axle 124. The separatory funnel body 110 has a barrel-shaped upper part 118 with a cone lower part 116. A wide-open 114 at the top end transfers liquid phases with a screw threaded joint 112. The separatory funnel body 110 has a tube-shaped 120 attached with a stem 122 at the bottom. The tube-shaped 120 fits the axle 124 to form a stopcock. The axle 124 has a small aperture 126 in the center for turning on/off the stopcock. The barrel-shaped funnel body 110 is made from an injection-molding machine, therefore the internal diameter of the barrel-shaped funnel part 118 should be identical from top to bottom. However, for convenient manufacturing process, the top part should be slightly bigger than bottom part of 118. The axle 124 is also made from an injection molding machine.

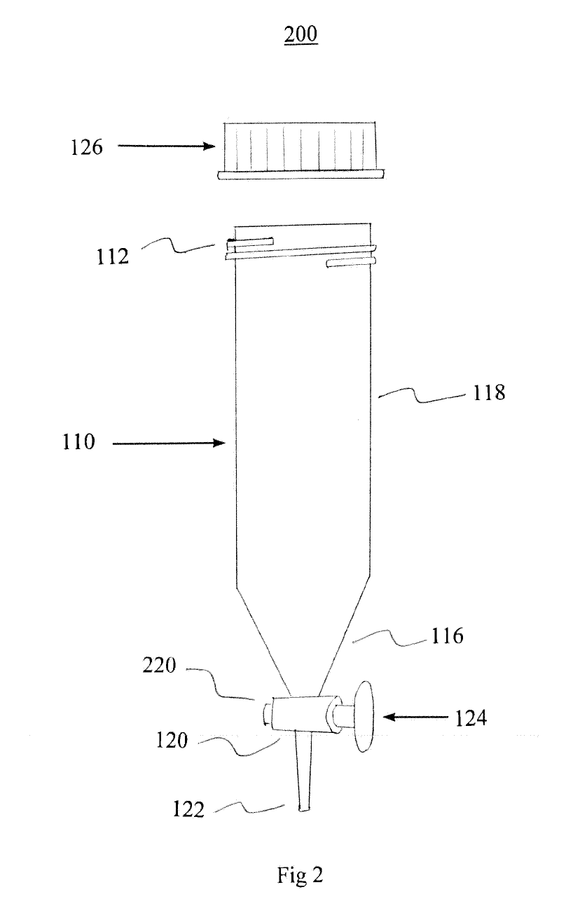

FIG. 2 shows a complete set of polymer-structured separatory funnel indicated by number 200. The separatory funnel 110 has a barrel-shaped upper part 118 with a cone lower part 116. A screw threaded joint 112 at the top to seal the funnel with a screw threaded cap 126. The bottom is a one-way on/off stopcock 220, which consists of tube-shaped 120 and the axle 124. A stem 122 at the bottom end drains liquid phases.

The separatory funnel 200 is used primarily for liquid-liquid phase extraction/separation. When two immiscible liquid phases are added into the funnel 110, the stopcock 220 is turned off and the cap 126 is capped on the screw thread 112. Then an extraction process is operated. After the two layers are formed, the higher density liquid phase can be drained out first, so the two liquid phases are separated.

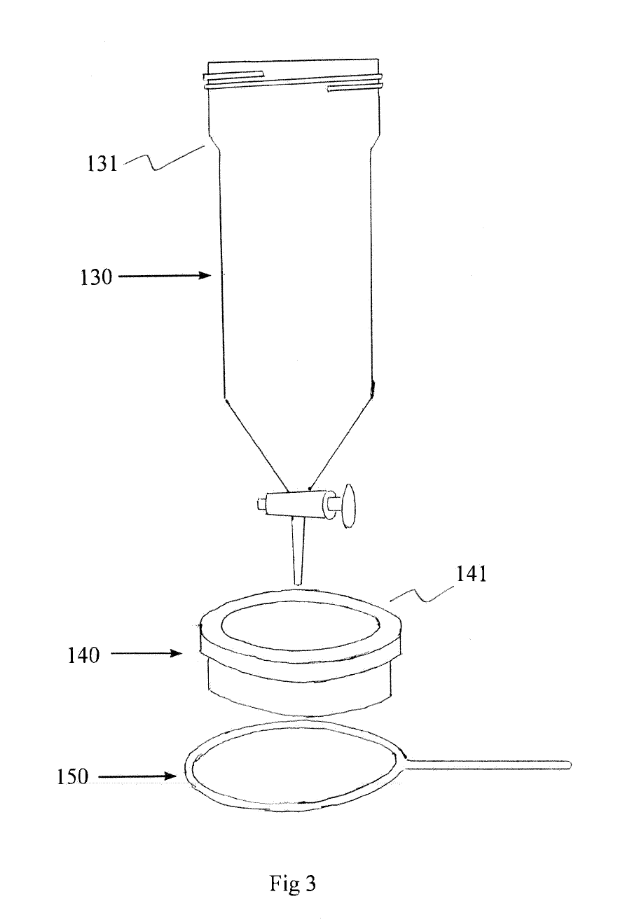

The separatory funnels with small diameter of funnel body can be directly held with a clamp during the operating process. However, for larger diameter of funnel body, a support ring may be needed as showed in FIG. 3. A separatory funnel body 130 with an indent 131 on the upper part can be held with a ring 140. The ring 140 with a wider edge 141 is placed on a metal support ring 150. The ring 140 is made of plastic or metal material.

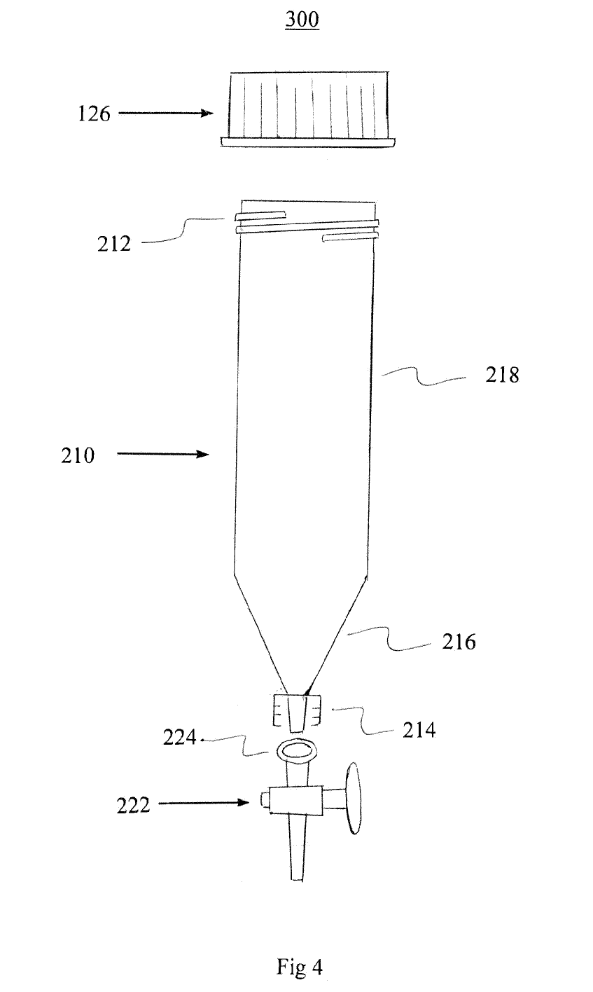

FIG. 4, a polymer-structured separatory funnel indicated by number 300, is shown. The separatory funnel body 210 has a barrel-shaped upper part 218 with a cone-shaped lower part 216. A screw-threaded joint 212 at the top fits the cap 126. The bottom end is a male luer-lock joint 214 to fit one-way on/off stopcock 222 with a female joint 224. The barrel-shaped funnel body 210 is made through the injection molding machine, therefore the internal diameter of the barrel-shaped upper part 218 should be identical from top to bottom. However, for convenient manufacturing processes, the top part should be slightly bigger than bottom part of 218. Usually, the separatory funnel body 110 made through the injection molding machine is in one piece. However, it may have process issues to manufacture large size of funnels. Therefore, large separatory funnel may be designed into two parts: a separatory funnel body 210 with a male luer-lock joint 214 at the bottom and a one-way on/off stopcock 222 with a female joint 224. The stopcock 222 is also made through injection molding machine.

The separatory funnels not only have to resist corrosion from various organic solvents but also should be transparent. The separator funnel can be made of a polymer material. The polymer material can be an acrylonitrile butadiene styrene copolymer, a polyethylene, a polypropylene, a polystyrene, a polyvinylchloride, a nylon (for example, an 11 nylon, a 12 nylon, a 6/10 nylon, a 6/6 nylon, a 6/12 nylon), a polyphenylene sulfide, a polysulfone, a polyurethane, a polyetherimide, a polycarbonate, a polyetherimide, a polyacetal, a polyphenylene, a polyacrylate, a polycellulose acetate, a polycellulose buryrate, a polycellulose propionate, a polyethylene vinyl acetate, a polybutylene, a polyester, or copolymers or blends thereof. In certain embodiments, the polymer can be, an inexpensive polypropylene or polyethylene selected as the material meets the requirement. The capacity size of the separatory funnels is between 5 to 5000 milliliters, for example, 5, 10, 20, 50, 100, 150, 200, 250, 300, 400, 500, 1000, 1250, 1500, 1750, 2000, 2500, 3000, 3500, 4000, 4500 or 5000 milliliters. The separatory funnels can be packaged in combinations of 2, 3, 4, 5, or 6 different sizes.

Compared with other separatory funnels, there are at least two advantages for the polymer-structured separatory funnels. The first is the lower cost with high quality. The quality of the funnel can be determined by evaluating a rate of leakage, failure under reduced pressure, or variation in thickness. Accordingly, an inexpensive polypropylene or polyethylene can be selected as the material meets the requirement. The second is their multi-functional features.

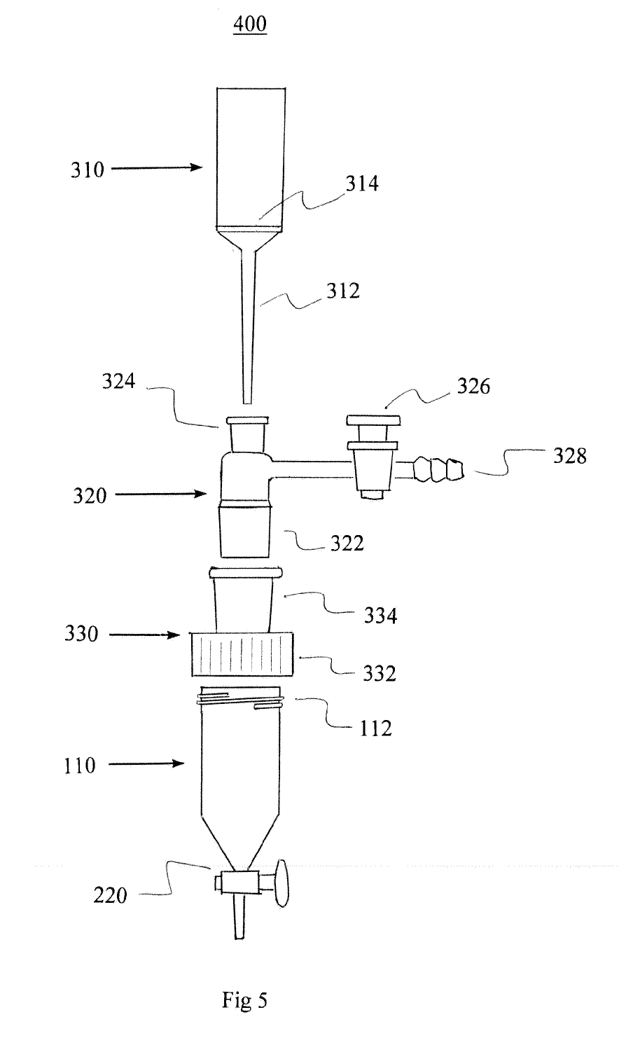

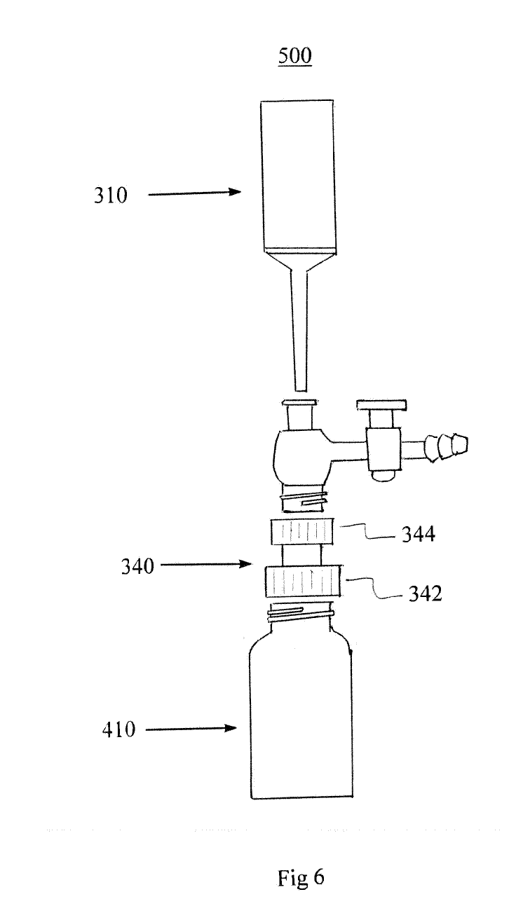

The separatory funnel as a receiving receptacle can be used in a solid-liquid filtration apparatus to take filtrate. With reference to FIG. 5, an exploded view of the filtration apparatus, is generally indicated by numeral 400. The apparatus consists of a polymer-structured filter funnel 310, a glass vacuum take-off adapter 320, a polymer-structured adapter 330, and a polymer-structured separatory funnel 110. The screw threaded joint 112 of the separatory funnel 110 fits the screw threaded joint 332 of adapter 330. The ground joint 334 couples with the ground joint 322 of glass vacuum take-off adapter 320 and the ground joint 324 receives the stem 312 of the funnel 310. The filter funnel 310 has a long stem 312, which extends past the glass vacuum take-off adapter 320 and adapter 330 into the separatory funnel 110, as shown. The long stem 312 extends into the separatory funnel 110 so as to prevent contamination of adapters 320 and 330 by filtrate when under negative pressure from an attached vacuum source connected to port 328. Actually, we filed a US patent (Disposable Polymer-Structured Filtering Kit, US2010/0038303A1), in which a solid-liquid filtration apparatus with numeral 500 as showed in FIG. 6. The separatory funnel 110 as a receiving receptacle can replace the glass vial/flask 410 to take filtrate in that solid-liquid phases filtration system.

The adapter 330 can be made of a fluorinated polyethylene, a polyvinylidene fluoride (PVDF) or a polypropylene. The ground joint 334 has different standard sizes such as 14/20, 19/22, 24/40 and 29/42 to fit different size of joint 322. The screw threaded joint 332 will be designed to fit the different size of joint 112 of separatory funnel 110. The adapter 340 showed in FIG. 6 with both screw threaded joints 342 and 344 is also used in the apparatus.

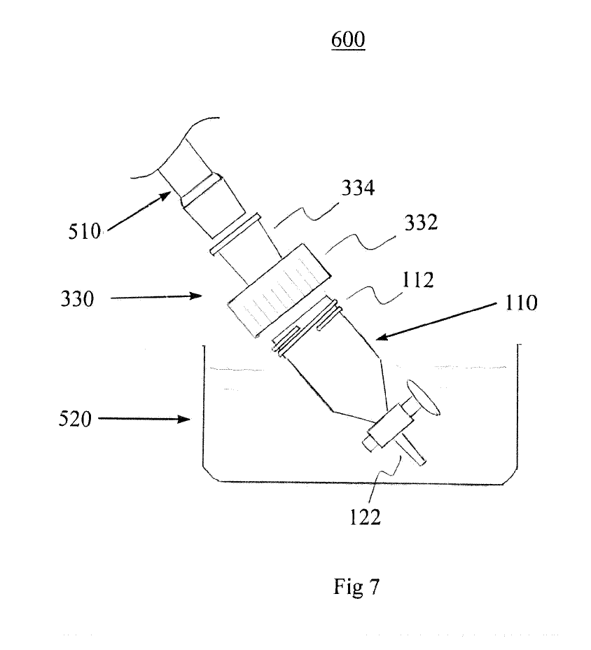

The separatory funnel 110 as a vial/flask can be hooked to a regular rotary evaporator to evaporate solvent as shown in FIG. 7. An exploded view of the partial rotary evaporator apparatus, generally indicated by numeral 600, is shown. The partial rotary evaporator apparatus 600 consists of a polymer-structured separatory funnel 110, a polymer-structured adapter 330, a ground joint 510 of a rotary evaporator (not showed), and a water bath container 520. The screw threaded joint 112 of the separatory funnel 110 fits the screw threaded joint 332 of adapter 330. The ground joint 334 directly couples with the ground joint 510 of a rotary evaporator to evaporate solvent under reduced pressure. Usually, a commercially available separatory funnel has a long stem tip. Since the separatory funnel 110 needs to be partially immersed in the water bath 520 to heat the solvent, the stem tip 122 should be shorter to prevent from touching the bottom of the water bath 520. In addition, the shorter stem tip will save space for shipping and storage.

A general method of manufacturing polymer-structured separatory funnels involves in the following procedures by using injection molding machines in which a desirable injection mold is made for separatory funnel body 110. The polymer resin is fed to the machine through the hopper. The resins enter the injection barrel by gravity through the feed throat. Upon entrance into the barrel, the resin is heated to the appropriate melting temperature. The resin is injected into the mold by a reciprocating screw or a ram injector. The mold is the part of the machine that receives the plastic and shapes it appropriately. The mold is cooled constantly to a temperature that allows the resin to solidify and be cool to the touch. The mold plates are held together by hydraulic or mechanical force. The clamping force is defined as the injection pressure multiplied by the total cavity projected area. Typically molds are overdesigned depending on the resin to be used. Each resin has a calculated shrinkage value associated with in.

### EXAMPLES

A typical reaction mixture in ethanol contains compounds A, B and C. Compound A is only soluble with organic solvents such as ethanol or ethyl acetate. Compound B is only soluble with polar solvents such as ethanol or water. Compound C is an insoluble solid. To the assembled solid-liquid filtration apparatus as shown in FIG. 5 is added the reaction mixture to the disposable filter funnel 310. The stopcock 220 is turned off and vacuum port 328 is connected to a vacuum source to suck the solution through filter funnel 310 into disposable separatory funnel 110 so the insoluble compound C is separated from the solid-liquid filtration. Because the long stem 312 is inserted into the separatory funnel 110, the adapters 320 and 330 are not contaminated so they do not need to be cleaned after use. The filtrate in separatory funnel 110 is hooked to the joint 510 of a rotary evaporator via the adapter 330 to concentrate the ethanol solvent under reduced pressure as shown in FIG. 7. After the ethanol solvent is removed, the resulting residue in separatory funnel 110 is dissolved with ethyl acetate and performed a liquid-liquid extraction with water shown in FIG. 2. The organic compound B is extracted into water phase and compound A still stay within organic phase. The water phase is drained from the short stem tip 122 by controlling the one-way on/off stopcock. The ethyl acetate solvent in separatory funnel 110 is concentrated directly with rotary evaporator 510 to afford compound A as shown in FIG. 7. The aqueous solution is concentrated with rotary evaporate to give compound B. In the example, the disposable separatory funnel 110 can be used as a receiving receptacle directly take filtrate in solid-liquid phases filtration, then as a flask hooked to a rotary evaporator for solvent evaporation, and as a separatory funnel for a liquid-liquid phase extraction. Finally, it is discarded after use.

In accordance with the principles of the present invention, the disposable separatory funnel is a significant improvement compared to prior art. It is apparent that modification and changes can be made within the spirit and scope of the present invention. But it is our intention, however, only to be limited by the appended claims.

1. A multi-functional separatory funnel, comprising:
a separatory funnel body having a top end and a bottom,
a one-way on/off stopcock at the bottom, and
a screw threaded joint at the top end.

2. The separatory funnel as recited in claim 1, further comprising a screw threaded cap configured to mate with the screw threaded joint.

3. The separatory funnel as recited in claim 1, wherein the separatory funnel body includes an injection molded polymeric material.

4. The separatory funnel as recited in claim 3, wherein the method of manufacture through injection molding machines includes the steps of A): feeding the polymer resin to a machine through a hopper; B): passing the resin through an injection barrel by gravity through a feed throat; C): upon entrance into the barrel, heating the resin to an appropriate melting temperature; D): injecting the resin into the mold by a reciprocating screw or a ram injector into a mold; E): cooling the mold to a temperature that allows the resin to solidify and be cool to the touch.

5. The separatory funnel as recited in claim 3, wherein the separatory funnel is disposable.

6. The separatory funnel body as recited in claim 1, wherein the separatory funnel body has a barrel-shaped upper portion adjacent to the top end and a cone-shaped lower portion adjacent to the bottom.

7. The separatory funnel as recited in claim 3, wherein the polymeric material of the separatory funnel body and screw threaded cap are made of polypropylene or polyethylene.

8. The separatory funnel as recited in claim 1, wherein the separatory funnel is used for liquid-liquid phase separation and extraction.

9. The separatory funnel as recited in claim 1, wherein the separatory funnel is used as a receiving receptacle to take the filtrate in a solid-liquid filtration apparatus.

10. The separatory funnel as recited in claim 8, wherein a polymer-structured adapter is used to couple the separatory funnel to a vacuum take-off adapter.

11. The separatory funnel as recited in claim 10, wherein the adapter includes a screw threaded joint and a ground joint opposite the threaded joint.

12. The separatory funnel as recited in claim 10, wherein the adapter includes a first screw threaded joint and a second screw threaded joint opposite the first screw threaded joint.

13. The separatory funnel as recited in claim 10, wherein the polymeric material of the adapter is selected from the group including polypropylene, polyethylene, fluorinated polyethylene, or polyvinylidene fluoride.

14. The separatory funnel as recited in claim 10, wherein the adapter has a ground joint with size of 14/20, 19/22, 24/40 or 29/42.

15. The separatory funnel body as recited in claim 1, wherein the separatory funnel body has an indent on the upper part, which can be held with a support ring.

16. A multi-functional separatory funnel, comprising:
a separatory funnel body with a wide-opened screw threaded joint at the top end and with a male luer-lock joint at the bottom, a one-way on/off stopcock with a female joint, and a screw threaded cap.

17. The separatory funnel as recited in claim 3, wherein the separatory funnel body and the one-way on/off stopcock are manufactured from an injection molding machine, in which their manufacture process are same as in claim 3.

18. The separatory funnel body as recited in claim 16, wherein the separatory funnel body has a barrel-shaped upper portion with a cone lower portion.

19. The separatory funnel as recited in claim 16, wherein the separatory funnel body and stopcock is made of polypropylene or polyethylene.

20. The separatory funnel as recited in claim 1, wherein the body includes an indent on the top end part configured to be held with a support ring.

21. A method of manufacturing a separatory funnel comprising:
feeding a polymer resin into a hopper,
melting the polymer resin,
injecting the polymer resin into a mold including a separatory funnel body having a top end and a bottom, a one-way on/off stopcock at the bottom, and a joint at the top end, and
cooling the polymer resin to form the funnel.

22. A method of using a separatory funnel comprising applying reduced pressure to an internal volume of the separatory funnel.

23. The method of claim 22, wherein applying reduced pressure includes attaching the separatory funnel to a rotary evaporator to evaporate volatile material.

24. The method of claim 22, wherein a polymer-structured adapter couples the separatory funnel with the rotary evaporator.

25. The method as recited in claim 22, further comprising performing a liquid-liquid phase separation and extraction prior to applying reduced pressure.

26. The method as recited in claim 22, further comprising receiving a filtrate directly from a solid-liquid filtration apparatus into the separatory funnel prior to applying reduced pressure.
